(19) United States
(12) Patent Application Publication
(10) Pub. No.: US 2007/0041891 A1
(43) Pub. Date: Feb. 22, 2007

(54) Aluminum chlorohydrate via anchored transformations of aluminum chloride

(76) Inventors: Joe D. Sauer, Baton Rouge, LA (US); George W. Cook JR., Baton Rouge, LA (US); Will S. Pickrell, Baton Rouge, LA (US); Joseph E. Coury, Friendswood, TX (US)

Correspondence Address: EDGAR SPIELMAN;ALBEMARLE CORPORATION, 451 FLORIDA BLVD., BATON ROUGE, LA, 70801, US

(21) Appl. No.: 11/505,111

(22) Filed: Aug. 16, 2006

Related U.S. Application Data
(60) Provisional application No. 60/708,590, filed on Aug. 16, 2005.

(51) Int. Cl. C01F 7/48

(52) U.S. Cl. 423/495

(57) ABSTRACT

The present invention relates to a method for preparing aluminum chlorohydrate.

### REFERENCE TO RELATED APPLICATION

This application claims priority to U.S. Provisional Patent Application No. 60/708,590 filed Aug. 16,2005, the disclosure of which is herein incorporated by reference in its entirety.

### SUMMARY OF THE INVENTION

The present invention relates to a method for preparing aluminum chlorohydrate. More particularly the present invention relates to a method for preparing aluminum chlorohydrate from aqueous aluminum chloride via ion exchange.

### BACKGROUND OF THE INVENTION

Aluminum chlorohydrate (“ACH”) belongs to a class of compounds commonly referred to as polyaluminum chlorides. ACH is used in a variety of industrial applications, most notably in the antiperspirant industry. However, aluminum chlorohydrate also finds applicability in water treatment applications and is becoming a product of choice in such applications.

Two of the most common manufacturing processes used to produce ACH involve the addition of metallic aluminum to aluminum chloride and the electrolysis of aluminum chloride, see Kirk-Othemer. Encyclopedia of Chemical Technology. 4^{th} edition, volume 2, 1992, pages 287-288 and 342-345. Both of these processes suffer the drawback that hydrogen gas is produced during the ACH forming reactions, and thus, measures must be taken to prevent or retard the possibility of explosions.

Thus, there is a need in the art for a more effective, less hazardous, ACH manufacturing process.

### SUMMARY OF THE INVENTION

The present invention relates to a process for manufacturing aluminum chlorohydrate (“ACH”). The process comprises:
a) solubilizing aluminum chloride in a C₁-C₄ alcohol to form an alcoholic aluminum chloride solution;
b) adding an effective amount of water to the alcoholic aluminum chloride solution to form an aqueous alcoholic aluminum chloride solution complexed with an exchangeable chloride anion;
c) exchanging the exchangeable chloride anion with a hydroxy counter anion to produce an ion exchanged intermediate product comprising at least aluminum chlorohydrate product, at least one C₁-C₄ alcohol, and water; and
d) recovering the aluminum chlorohydrate product by removing at least a portion of the at least one C₁-C₄ alcohol and water from the ion exchanged intermediate product.

At least a portion of the C₁-C₄ alcohol removed from the ion exchanged intermediate product can be recovered and reused in the process.

The process can also further comprise regenerating the ion exchange bed by conducting caustic through the ion exchange bed.

### DETAILED DESCRIPTION OF THE INVENTION

Aluminum chloride suitable for use herein can be selected from anhydrous aluminum chloride; catalyst grade aluminum chloride such as, for example, solid crystalline aluminum chloride or complexed aluminum chloride; and hydrated aluminum chloride such as, for example, crystalline hexahydrate, liquid aqueous polyhydrate, and the like. It is preferred that the aluminum chloride used herein be a hydrated aluminum chloride.

In the practice of the present invention, aluminum chloride is solubilized in a C₁-C₄ alcohol to form an alcoholic aluminum chloride solution. C₁-C₄ alcohols suitable for use herein include methanol, ethanol, isopropanol, isopropyl alcohol, the like, and mixtures thereof. It is preferred that only one C₁-C₄ alcohol be used, and it is even more preferred that the only one C₁-C₄ alcohol be methanol.

The aluminum chloride is solubilized in the C₁-C₄ alcohol by mixing it with about 1 wt. % to about 30 wt. % of the C₁-C₄ alcohol, based on the aluminum chloride. Preferably, the aluminum chloride is solubilized by mixing it with about 5 to about 20 wt. % C₁-C₄ alcohol, on the same basis, more preferably, about 5 to about 15 wt. % C₁-C₄ alcohol, on the same basis.

An effective amount of water is then added to the aluminum chloride solution to form an aqueous alcoholic aluminum chloride solution complexed with an exchangeable chloride anion. By an effective amount of water, it is meant that amount of water necessary to provide an aqueous alcoholic aluminum chloride solution complex comprising about 10 to about 30 parts aluminum chloride, about 40 to about 70 parts alcoholic solvent, and about 10 to about 30 parts water. Preferably, an effective amount of water is that amount necessary to provide an aluminum chloride solution complex comprising about 15 to about 25 parts aluminum chloride, about 45 to about 65 parts alcoholic solvent, and about 15 to about 25 parts water.

It is highly desirable that the aqueous alcoholic aluminum chloride solution of the present invention possess two attributes. First, it is desirable that the aqueous alcoholic aluminum chloride complex have a relatively low viscosity. By relatively low viscosity, it is meant a viscosity of up to about 1000 cp at 25° C. Secondly, it is desirable that the aqueous alcoholic aluminum chloride complex demonstrates a significant ionization to the exchangeable aluminum ion, i.e. a (+3) aluminum cation, and an exchangeable chloride ion, i.e. a (−1) chloride anion. By significant ionization it is meant that at least about 10% of the aluminum and chlorine ions present in the aqueous alcoholic aluminum chloride complex are (+3) aluminum cation and (−1) chloride anion, preferably at least about 25%.

The complexed chlorine anion is then exchanged with a hydroxy counter anion to produce an ion exchanged intermediate product comprising at least an aluminum chlorohydrate product, C₁-C₄ alcohol, and water. The exchange of the complexed chlorine anion is conducted by ion-exchange chromatography. “Ion exchange chromatography” and “ion exchange” as used herein refers to a technique whereby charge substances are separated via oppositely charged resin materials. These resin materials are typically present as a gel matrix in an ion exchange column, and the resin material is first modified with small concentrations of counter anions, in this case hydroxide counter anions, which are typically in buffer solutions. In the present invention, caustic is preferably used to modify the resin material with hydroxide counter anions. When a material is added to the column, an exchange between the resin material's anion and the weakly bound counter anions, here the complexed chloride anion, takes place.

Resins used in ion exchange are typically differentiated as “basic” (positively charged) and “acidic” (negatively charged). In turn, the basic and acidic type resins can be subdivided into those that are “strongly acidic” and “strongly basic”. In the practice of the present it is preferred to use strongly basic ion exchange resins. Strongly basic ion exchange resins are typically composed of functionalized styrene divinylbenzene or polyacrylic copolymers possessing different surface properties and porosities. These resins are supplied as gels or macroreticular beads. Some commonly available ion exchange resins that are suitable for use herein include Amberlite , available commercially from the Rohn & Haas Company, Dowex™, available from the Dow Corporation, and Marathon 2A™, also available from the Dow Corporation.

Before the aqueous alcoholic aluminum chloride solution can undergo ion exchange, the ion exchange resin/column must first be prepared and equilibrated. Typically, the readily available ion exchange resins are marketed in a “chloride” ion form. Therefore, the resin/column must be converted to the hydroxide (OH⁻) counter anion for use in the present invention. The preparation of an ion exchange column is well known in the art. The present invention is not limited to one specific preparation method, and any preparation method known can be used. One such preparation method involves plugging one end of a column and adding to the plugged column the desired amount of ion exchange resin.

Once the resin is allowed to settle, the counter anion is charged to the column. In the present invention, once the resin is allowed to settle, caustic, i.e. sodium hydroxide, is conducted through the ion exchange column in order to “charge” the ion exchange resin with the desired hydroxide (OH⁻) counter anion. As the sodium hydroxide passes through the ion exchange column, the hydroxide counter anion is exchanged for the chlorine anions present in the ion exchange resin. After the ion exchange column has been converted to the hydroxide counter anion, the column is washed by passing a C₁-C₄ alcohol/water mixture through the column. In certain aspects, the alcohol/water mixture is about 85 wt. % to 95 wt. % methanol, based on the alcohol water mixture, with the remainder being water.

After the column has been washed, the aqueous alcoholic aluminum chloride solution complexed with the exchangeable chloride anion is conducted through the column. As the aqueous alcoholic aluminum chloride solution passes through the ion exchange column, the complexed chlorine ions are exchanged with the hydroxide counter anions, thus forming the ion exchanged intermediate product. When the ion exchanged intermediate product “front” reaches the exit of the column, the surface tension of the effluent can be altered to increase the flow rate through the ion exchange column. In general, the change in flow rate of the alcoholic aluminum chloride solution and a noticeable shift to a more basic pH indicates the formation of the ion exchanged intermediate product. Any ion exchanged intermediate product remaining in the ion exchange column can be suitably recovered by again passing a C₁-C₄ alcohol/water mixture through the column.

The conditions under which ion exchange beds are operated are well known in the art. However, in the practice of the present invention, it is preferred that the ion exchange bed be operated under conditions effective at producing an ion exchanged intermediate product wherein the aluminum chlorohydrate product present therein comprises a majority of aluminum chlorohydrate product represented by the formula Al₂(OH)₅Cl₁. By a majority, it is meant greater than about 50%, preferably greater than about 75%, of the aluminum chlorohydrate product in the ion exchanged intermediate product is represented by the formula Al₂(OH)₅Cl₁. The conditions under which this majority is produced include ambient temperatures and pressures and flow rates that can be easily selected by one having ordinary skill in the art.

As the ion exchange bed is used to exchange the hydroxide ions, the bed is converted to a chloride bed. This increase in chloride ions in the ion exchange bed decreases the effectiveness and efficiency of the ion exchange bed. However, the ion exchange bed can be regenerated by conducting caustic through the bed to replace the chloride ions therein with hydroxide counter anions. Thus, one aspect of the present invention relates to a further step of regenerating the ion exchange bed by washing it with caustic, as described above. It should be noted that the sodium chloride produced by charging and recharging the bed can be suitably recovered.

The aluminum chloride product present in the ion exchanged intermediate product is recovered by removing at least a portion, preferably substantially all, of the C₁-C₄ alcohol and water from the ion exchanged intermediate product. The method by which the water and alcohol are removed is not critical to the instant invention and suitable methods include distillation, centrifugation, stripping, removing the water as an azeotrope with the alcohol, and the like. It is preferred that stripping be used.

At least a portion, preferably substantially all, of the C₁-C₄ alcohol removed from the aluminum chlorohydrate product can be recovered and recycled for use in solubilizing the aluminum chloride in the first step of the present invention. The C₁-C₄ alcohol can be separated from the water by any known techniques, or is more suitably used in combination with the water in the second stage of the instant invention. In this embodiment, water and/or C₁-C₄ alcohol can be added to provide an aqueous alcoholic aluminum chloride solution having the above-described aluminum chloride/water/C₁-C₄ alcohol ratios.

The aluminum chlorohydrate product produced by the instant invention can be represented by the formula Al₂(OH)₆₋ₘClₘ, wherein m ranges from about 1 to about 6. Thus, the aluminum chlorohydrate produced by the instant invention can range from Al₂(OH)₅Cl₁ to Al₂(OH)₁Cl₅. The aluminum chlorohydrate can also take on the form of poly aluminum chlorohydrate wherein more than two aluminum atoms are present. The actual form and depth, i.e. number of aluminum atoms, of the aluminum chlorohydrate produced by the instant invention depends on the operation of the ion exchange column and can be adjusted to meet the product requirements desired. However, as stated above, it is preferred that the aluminum chlorohydrate product be represented by the formula Al₂(OH)₅Cl₁.

The above description is directed to several means for carrying out the present invention. Those skilled in the art will recognize that other means, which are equally effective, could be devised for carrying out the spirit of this invention. The following examples will illustrate the present invention, but are not meant to be limiting in any manner.

### EXAMPLES

### Example 1

### Preparation of Ion Exchange Column

A glass column [28 mm×150 mm] fitted with Teflon stopcock was filled with distilled, deionized water. Marathon 2A Dowex® resin [a strong base, ion exchange resin system] (40 g) was added gradually with drop-wise flow of water to effectively pack the column in a down-flow fashion. A total of 50 mL water was subsequently washed through the resin to pack the bed, establish flow parameters, and wash any contaminants out of the equipment. Theoretical and empirical bed parameters include the following details:
Water content (initially, as supplied) about 45%
Surface area about 65 m²/g
Porosity about 51%
Ion Exchange Capacity 0.7 meq/mL or 2.6 meq/g
Resin density about 0.7 g/mL
Total column volume (as assembled above) about 54 mL
Calculated column volume (per above) about 57 mL
Void Volume about 22 mL

Once the bed was formed and washed as outlined above, the resin was pretreated with a solution of sodium hydroxide [18 g NaOH in 300 mL water, about 5.7% caustic solution] by allowing the solution of sodium hydroxide to flow through the bed at a rate of about 1 mL/minute. Final pH of the eluent (by pH test strips) was greater than 13. After this treatment, the bed was further washed, at the flow rates as before, with 300 mL deionized, distilled water. Final pH of the eluent from this wash step was about 7.

This ion-exchange bed was used without further modification in example 2 below.

### Example 2

### Ion Exchange Treatment of Aluminum Chloride with Water as Eluting Solvent

A sample of anhydrous aluminum chloride (2.25 grams, 0.017 mole) was transferred to a 40 mL vial in a dry box thus forming a “mini reactor”. This mini-reactor was removed and placed in a fume hood wherein the vial was unsealed and allowed to stand in ambient conditions exposed to humid air (relative humidity variable but above 50%) overnight. At this point, water was added drop wise allowing the HCl formed to vent to the interior of the hood. When reaction subsided, additional water (total 25 mL) was added to afford a milky solution (about 9% in solids, based on the milky solution). This concentrate was further diluted with another 25 mL water to afford a “solution” with a concentration of approximately 4 to about 5% solids, based on the solution. This solution was added to the pre-conditioned ion exchange column from Example 1 and attempts were made to cause the contained aluminum compound to elute from the column. This experiment was very difficult to get to proceed. Materials were gummy and gelatinous. The “column” tended to come apart (i.e., to generate voids and air spaces and generally operate in very unsatisfactory manner) and after several attempts to correct the situation, the experiment was stopped and the materials were discarded.

### Example 3

### Preparation of Ion Exchange Column for “Anchored Transformation” Experiments with Methanol/Water Elution

A glass column [28 mm×150 mm] fitted with Teflon stopcock was filled with distilled, deionized water. Marathon 2A Dowex® resin (40 g) was added gradually with drop-wise flow of water to effectively pack the column in a down-flow fashion. A total of 50 mL water was subsequently washed through the resin to pack the bed, establish flow parameters, and wash any contaminants out of the equipment. Theoretical and empirical bed parameters include the following details:
Water content (initially, as supplied) about 45%
Surface area about 65 m²/g
Porosity about 51%
Ion Exchange Capacity 0.7 meq/mL or 2.6 meq/g
Resin density about 0.7 g/mL
Total column volume (as assembled above) about 54 mL
Calculated column volume (per above) about 57 mL
Void Volume about 22 mL

Once the bed was formed and washed as outlined above, the resin was pretreated with a solution of sodium hydroxide [18 g NaOH in 300 mL water, about 5.7% caustic solution] by allowing said solution to flow through the bed at a rate of about 1 mL/minute. Final pH of the eluent (by pH test strips) was greater than 13. After this treatment, the bed was further washed, at similar flow rates as before, with 300 mL deionized, distilled water. Final pH of the eluent from this wash step was about 7.

After the bed was prepared in the normal fashion described, it was then converted to a mixed solvent system (methanol/water) to control the efficiency of ion exchange in the anchored transformation step carried out in Example 4. To carry out this conversion, the bed was washed, in a down-flow manner, with 2×100 mL aliquots of a solution comprised of a ratio of 60:30 methanol/water. Flow rates were again controlled at approximately 1 mL/minute. The “pH” of the final wash eluent (by pH strip measurement) was 6.5 to 7.0.

This ion-exchange bed was used without further modification in Example 4 below.

### Example 4

### Ion Exchange Treatment of Aluminum Chloride with Methanol/Water as Eluting Solvent System

As before, a sample of anhydrous aluminum chloride (2.25 grams, 0.017 mole) was transferred to a 40 mL vial in a dry box thus forming a mini-reactor. This mini-reactor was removed and placed in a fume hood wherein the vial was unsealed and allowed to stand in ambient conditions exposed to humid air (relative humidity variable but above 50%) overnight. A volume of 12 g (0.375 mole) methanol was added and the vial was allowed to stand overnight.

At this point, water was added drop wise allowing the HCl formed to vent to the interior of the hood. When reaction subsided, additional water (total 2 mL) was added to afford a mobile solution (about 14% in solids, based on the mobile solution). The “pH” of this solution (a fairly low-viscous, clear liquid) was about 2.0. Chlorine test strips gave a 9+ indication (which would be >40,000 ppm according to their calibration curve supplied by the vendor; theoretical value should have been about 10,000 ppm—which would indicate that these test strips tend to read about 4× high in the methanol/water systems being utilized.

The mobile solution was further diluted with an additional 6.5 g water and this diluted material was then gently and carefully added to the top of a pre-conditioned ion exchange column (prepared as in Example 3). The bed was developed by elution with a 60:30 methanol/water solution. Fractions were obtained as the column was allowed to run. Details of the composition of the eluate per fraction are given in the Table below. Initial chloride values for the untreated solution were about 3,125 ppm.

TABLE

| Fraction | Volume | pH | Chloride # | Chloride ppm |
|---|---|---|---|---|
| 0 | Pre-column | 2.0 | 6 | 3000 |
| A | 20 mL | 5.0 | 0.8 | <30 |
| B | 20 mL | 3.5 | 4.2 | 1360 |
| C | 20 mL | 4.0 | 3.2 | 104 |
| D | 20 mL | 4.5 | 2.0 | 50 |

The material collected from the ion exchange system, as run in the mixed solvent system described, can be admixed with aqueous aluminum chloride to achieve any desired ratio of Aluminum to Chlorine in the various compositions present in aluminum chlorohydrate. As described and demonstrated, this technique allows for the simple production of a variety of high quality ACH materials with compositions readily determined and tunable to performance criteria as necessary.

What is claimed:

1) A process for manufacturing aluminum chlorohydrate (“ACH”) comprising:
a) solubilizing aluminum chloride in a C₁-C₄ alcohol to form an alcoholic aluminum chloride solution;
b) adding an effective amount of water to the alcoholic aluminum chloride solution to form an aqueous alcoholic aluminum chloride solution complexed with an exchangeable chloride anion;
c) exchanging the exchangeable chloride anion with a hydroxy counter anion to produce an ion exchanged intermediate product comprising at least aluminum chlorohydrate, at least one C₁-C₄ alcohol, and water; and
d) recovering the aluminum chlorohydrate product by removing at least a portion of the at least one C₁-C₄ alcohol and water from the ion exchanged intermediate product.

2) The process according to claim 1 wherein said C₁-C₄ alcohol used in solubilizing the aluminum chloride is selected from methanol, ethanol, isopropanol, isopropyl alcohol, the like, and mixtures thereof.

3) The process according to claim 1 wherein only one C₁-C₄ alcohol is used in solubilizing the aluminum chloride.

4) The process according to claim 3 wherein the only one C₁-C₄ alcohol is methanol.

5) The process according to claim 1 wherein the aluminum chloride is solubilized in the C₁-C₄ alcohol by mixing the two in a ratio of about 1 wt. % to about 30 wt. % C₁-C₄ alcohol, based on the aluminum chloride.

6) The process according to claim 2 wherein the aluminum chloride is solubilized in the C₁-C₄ alcohol by mixing the two in a ratio of about 5 to about 20 wt. % C₁-C₄ alcohol, based on the aluminum chloride.

7) The process according to claim 4 wherein the aluminum chloride is solubilized in the C₁-C₄ alcohol by mixing the two in a ratio of about 5 to about 15 wt. % C₁-C₄ alcohol, based on the aluminum chloride.

8) The process according to claim 1 wherein said effective amount of water is that amount of water necessary to provide for an aqueous alcoholic aluminum chloride complex comprising about 10 to about 30 parts aluminum chloride, about 40 to about 70 parts alcoholic solvent, and about 10 to about 30 parts water.

9) The process according to claim 7 wherein said effective amount of water is that amount necessary to provide an aluminum chloride complex comprising about 15 to about 25 parts aluminum chloride, about 45 to about 65 parts alcoholic solvent, and about 15 to about 25 parts water.

10) The process according to claim 9 wherein the aqueous alcoholic aluminum chloride complex has a viscosity of up to about 1000 cp at 25° C.

11) The process according to claim 10 wherein the aqueous alcoholic aluminum chloride complex demonstrates a significant ionization to the exchangeable aluminum ion.

12) The process according to claim 11 where at least about 10 percent of the aluminum and chlorine ions present in the aqueous alcoholic aluminum chloride complex are (+3) aluminum cation and (−1) chloride anion.

13) The process according to claim 12 wherein at least a portion of the C₁-C₄ alcohol removed from the ion exchanged intermediate product is recovered and reused in the process.

14) The process according to claim 13 wherein the process further comprises regenerating the ion exchange bed by conducting caustic through the ion exchange bed.
